(19) United States
(12) Patent Application Publication
(10) Pub. No.: US 2008/0011740 A1
(43) Pub. Date: Jan. 17, 2008

(54) Device for heating a drinking vessel

(75) Inventor: Frank Goltenboth, Blaustein (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: WMF WUERTTEMBERGISCHE METALLWARENFABRIK AG, Geislingen (DE)

(21) Appl. No.: 11/805,042

(22) Filed: May 22, 2007

(30) Foreign Application Priority Data
Jul. 14, 2006 (EP) 06 014 755.0

(51) Int. Cl. H05B 6/02

(52) U.S. Cl. 219/600

(57) ABSTRACT

A device (10) for heating a drinking vessel (5), particularly for a drink machine (1), whereby said device (10) has a receptacle mechanism (11) for the drinking vessel (5) with a steam delivery (13) into the interior (5a) of the drinking vessel (5). In order to create a device of this type in a manner that is simple in construction, safe and effective, the steam delivery (13) has a steam distribution chamber (15) arranged on the side of the cover (12) that lies opposite the covering surface (12a), whereby this steam distribution chamber (15) is connected to a steam intake (14) and empties into the covering area (12a) via at least one opening (16).

### CROSS-REFERENCE TO RELATED APPLICATION

The present application claims the benefit of priority of European Patent Application No. EP 06014755.0 filed on Jul. 14, 2006. The entire text of the priority application is incorporated herein by reference in its entirety.

### FIELD OF THE DISCLOSURE

The disclosure relates to a device for heating a drinking vessel, such as used with drink vending machines and coffee machines.

### BACKGROUND OF THE DISCLOSURE

Such a device is known from FR 2 716 792. The known device is part of a coffee machine and contains a receptacle mechanism for holding a drinking vessel that is to be preheated. The receptacle mechanism contains a type of inverted plate on to which is placed the drinking vessel, with the opening facing down. In the center of the plate is a nozzle mechanism that fits into the plate and protrudes from the plate. The nozzle mechanism has a multiple number of small openings that ensure a high steam flow velocity. The nozzle openings are connected to a steam intake by means of the hollow interior of a valve lifter. The steam delivery is formed in such a way that the steam flows essentially linearly through the interior of the valve lifter and into the nozzle openings. As a result of this development, however, danger to the user cannot be ruled out if, for example, a cup is not positioned correctly or if the preheating mechanism is activated when no cup is located in it.

A further device, known from DE-U-93 17 669, contains a valve body and a mushroom-shaped cap that is movable relative to the valve body and rigidly connected to a closing member with which a steam intake opening below the mushroom-shaped cap can be opened and closed. The cup to be preheated is put on over the valve body in an inverted position, i.e., with the opening facing down, until some point of the cup wall lies against the mushroom-shaped cap and presses the mushroom-shaped cap downwards. In this way, the steam intake valve is opened and steam can flow into the interior of the cup and heat up the wall of the cup. The known device has a number of disadvantages, however. For example, the mushroom-shaped cap shields the area at the bottom of the drinking vessel from steam access, so that this area does not heat up. This is particularly disadvantageous in the case of small or strongly conical drinking vessels, in which, in this manner, a large portion of the wall of the drinking vessel is shielded from steam contact, while the steam under the rim of the cup can pour out and endanger the user.

Furthermore, the known device can be only inadequately adapted to drinking vessels of differing diameters and/or heights, whereby the valve body and the mushroom-shaped cap must have a relatively small diameter for the most universal application possible. Relatively small diameters carry with them a risk, however, that a positioned cup does not find sufficient support and tips, so that an escaping stream of steam could endanger the user.

### SUMMARY OF THE DISCLOSURE

The object of the disclosure is consequently to provide a device for heating a drinking vessel whereby, in a manner with a simple design, the device offers safe function and functions correctly, essentially independently of the size of the drinking vessel.

As a result of the steam distribution chamber provided in accordance with the disclosure on the side of the cover and arranged between the steam intake and the opening on the covering surface, the steam is abated so that it cannot endanger the user, even if the preheating device were to be operated without a cup in position. Furthermore, the steam distribution chamber provides a first depositing of condensate that has been carried along, so that this cannot squirt out of the opening of the covering surface. In spite of this, the preheating capacity is not reduced by the steam distribution chamber in accordance with the disclosure.

The steam distribution chamber is preferably formed as a condensate collection device, which catches and safely diverts both the condensate carried along with the steam and, in the case that the covering surface is formed as a base for positioning the drinking vessel, the condensate that flows down the wall of the drinking vessel.

The preheating process is advantageously initiated by the user himself/herself. In order to prevent the steam delivery from being initiated inadvertently without there being an intent to preheat a drinking vessel, one or preferably two valves that can be operated by the user are provided in the steam delivery, whereby both of these valves must be activated in order to open the steam delivery for a preheating process.

Advantageously, this is, for example, a valve that can be activated mechanically by a movement of the cover, which, for example, can be opened by the weight of the drinking vessel, supported, where appropriate, by a slight pressure applied to the drinking vessel in the direction of the cover, and/or a valve that can be activated via an operating element (touch pad, key, button or the like), whereby the valve can, for example, be formed as a pre-selection for initiating a preheating process.

According to the disclosure, the opening leading into the interior of the drinking vessel is formed as at least one simple through-hole in the cover, which therefore can take on a sufficiently large diameter in order to avoid a nozzle effect, i.e., to prevent the steam from shooting out.

The covering surface can also contain a steam-permeable area with a multiple number of openings or through-holes, e.g., in the form of a perforated cover, a sieve, a weave or the like.

Furthermore, a steam-labyrinth section, which prevents the steam delivered by a steam generator via a steam line from being emitted in a direct jet, serves to increase the safety.

An abatement of the steam flow can also be effected by the steam intake that empties into the steam distribution chamber at right angles to the opening.

The cover preferably contains a base for positioning the inverted drinking vessel. This has the advantage that gravity can work in a supporting manner for an all-sided, sealing contact of the cover with the rim of the drinking vessel around the opening.

Possible endangering of the user is furthermore strongly reduced if the covering surface lies on the rim of the drinking vessel all around, i.e., forms a seal with the rim of the drinking vessel.

The device according to the disclosure can be formed as an auxiliary device and, for example, be equipped with its own steam generation, but preferably it is integrated into a drink machine and uses the steam generation provided there and, where appropriate, also the control mechanism.

### BRIEF DESCRIPTION OF THE DRAWINGS

Embodiments of the disclosure are explained in more detail in the following, using the drawings. Shown are:

FIG. 1 a perspective, heavily schematised depiction of a drink machine equipped according to the disclosure,

FIG. 2 a schematic depiction of a first embodiment of a device according to the disclosure, in section,

FIG. 3 a schematic depiction of a second embodiment of a device according to the disclosure, in section,

FIG. 4 a schematic depiction of a further embodiment of a device according to the disclosure, in section, and

FIG. 5 the view of the device according to FIG. 4, seen from the bottom.

### DETAILED DESCRIPTION OF THE DISCLOSURE

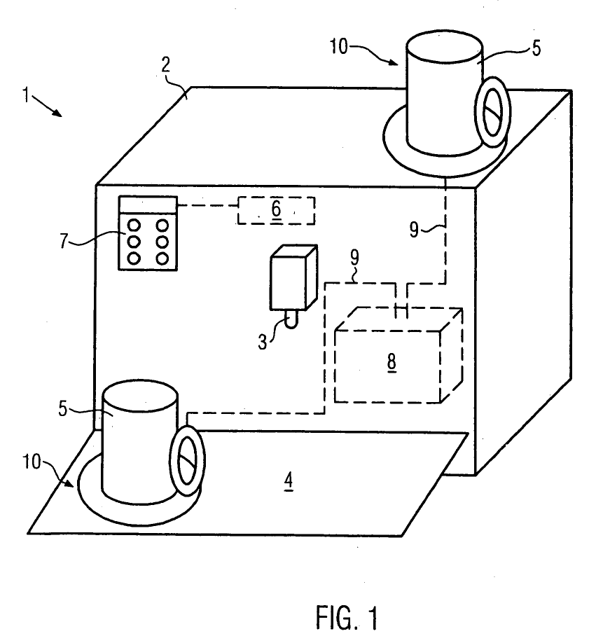

FIG. 1, in a strongly schematised depiction, shows a drink machine 1 according to the disclosure, whereby this can be one of the customary drink vending machines or, as shown, a coffee machine, such as is used, for example, in catering, cafeterias, self-service facilities, the household, or the like. A large number of drink machines of this type are known and do not have to be explained in more detail here. The drink machine 1 contains a housing 2 that accommodates the usual elements of the drink machine 1, for example, a brewing device for preparing one or more sorts of coffee drinks with an outlet 3 for dispensing the coffee drink, that empties above a base 4, formed, for example, as a drainage plate so that under the outlet 3, a drinking vessel 5 (cups are depicted) can be placed and filled. The initiation and performance of a drink preparation and dispensing process are effected by a control means 6, which is acted upon by means of operating elements 7. The operating elements 7 contain the customary keys, buttons, touch fields or the like, and are arranged on the exterior of the housing 2 in such a way as to be easily accessible to the user.

Also contained in the housing 2 is a steam generator 8, which, in turn, is shown only schematically. The steam generator 8 can have any design that is expedient for drink machines, and has a separate outlet (not depicted) or is connected to the outlet 3, in order to provide the user with steam for, for example, heating water for tea preparation, frothing milk or other purposes.

The steam preparer 8 is furthermore connected via a line 9 and a valve 9a to a device 10 for heating or preheating the drinking vessels 5.

Depicted in FIG. 1 are two devices 10 of this type, whereby the one device 10 is provided on the upper side of the housing 2, for example, close to a cup rack, and the other device 10 is provided on the base 4 at a distance to the outlet 3. The two devices 10 in the drawing are intended merely to show the preferred arrangement areas; the arrangement of a single device 10, at one of the depicted places or at other suitable places, is satisfactory for most purposes.

In the following, preferred embodiments of the device 10 are described, each of which is suitable for use with the drink machine 1 shown in FIG. 1.

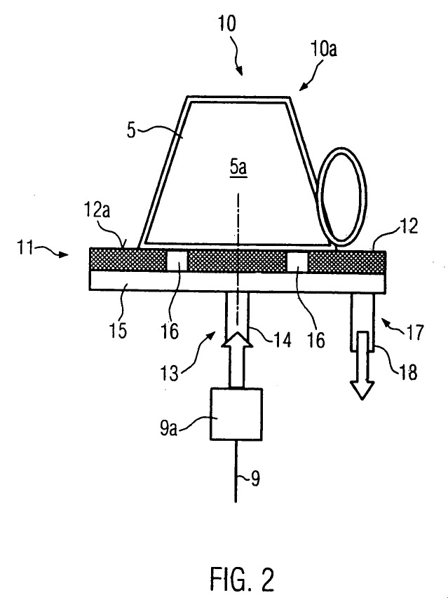

FIG. 2 shows a first embodiment 10a of a device 10 according to the disclosure for heating a drinking vessel 5 that is particularly suitable for a drink machine 1, but that can also be formed as a separate auxiliary device (and then provided with its own steam generator 8).

The device 10 contains a receptacle mechanism 11 for the drinking vessel 5, whereby said receptacle mechanism 11 contains a cover 12 with a covering surface 12a for the opening of the drinking vessel 5. The covering surface 12a is dimensioned in such a way that it seals the opening of the drinking vessel 5 and, with a sealing surface, preferably lies across the entire surface on the upper rim of the drinking vessel 5, so that contact between the covering surface 12a and the upper rim of the drinking vessel 5 provides a closure for the interior 5a of the drinking vessel 5 all along the circumference. The sealing surface can be formed by a smooth, level surface for contact across the entire surface with the rim of the drinking vessel or can be formed such that it is elastically pliable or the like. In the depicted embodiment, the covering surface 12a is formed as a base pointing upwards, on which the inverted drinking vessel 5 rests. The cover 12 has the shape of a panel or plate and the covering surface 12a is level, horizontal and sufficiently large in diameter so that even drinking vessels 5 with a large diameter can be securely supported.

The receptacle mechanism 11 furthermore contains a steam delivery 13, which contains a steam intake 14 that is connected to a steam preparer 8 via the valve 9a. The steam intake 14 empties into a steam distribution chamber 15, which is located on the side of the cover 12 that faces away from the covering surface 12a, i.e., preferably below the cover 12. The pressure of the introduced steam is reduced in the steam distribution chamber 15 and the steam looses any condensate that may have been carried along. At least one opening 16, emptying into the covering surface 12a, extends through the cover 12 (depicted are two openings, spaced next to one another at some distance apart), through which the steam can flow from the distribution chamber 15 into the interior 5a. The opening 16 is formed as a simple through-hole in the cover 12 and does not necessarily have to have the character of a nozzle, so that the steam flow velocity does not become too great and endanger the user.

The cover 12 can, however, also be provided with a steam-permeable area (not depicted) with a multiple number of openings 16, which, for example, is formed as a perforated area, a sieve or a weave or the like.

In the depicted embodiment, the steam intake 14 empties into the steam distribution chamber 15 at the delimiting wall of the steam distribution chamber 15 that lies opposite the cover 12 and is essentially centric with the covering surface 12a. The opening 16, on the other hand, is offset to the side of the inlet 14, so that the inlet 14 and the opening 16 are not aligned with each other, thereby forming a labyrinth section for the steam. The opening 16 is (or the openings 16 are) located, however, within the covering surface 12a and preferably so close to its center line (which is particularly important if more than one opening 16 is provided) that even small drinking vessels 5 can be easily preheated. The steam distribution chamber 15 is large enough to supply all provided openings 16 with steam.

The receptacle mechanism 11 furthermore contains a condensate collection mechanism 17. This uses the steam distribution chamber 15 as a condensate collector and contains a condensate outlet line 18, which is preferably provided at the lowest point of the steam distribution chamber 15. If the device 10 according to the disclosure is arranged on the drainage plate 4, the condensate can also be simply guided into the drainage pan.

The valve 9a is acted upon by the control mechanism 6, whereby the valve 9a can be opened by the user, for example, via one of the operating elements 7. The closing of the valve 9a can either likewise be effected by the user or it can take place automatically after the expiration of a predetermined time.

To preheat a drinking vessel, the user places the drinking vessel upside down on to the covering surface 12a and arranges the drinking vessel 5 in such a way that all openings 16 are covered, which can be simplified by a suitable marking on the covering surface 12a. Then the valve 9a is opened and steam flows via the inlet 14 into the steam distribution chamber 15 and from there through the openings 16 into the interior 5a of the drinking vessel 5, where it then preheats the drinking vessel. The condensate that arises flows back through the openings 16 into the steam distribution chamber 15 or arises in the steam distribution chamber 15, and is collected and taken away via the condensate outlet 18. After the conclusion of the steam delivery, the user can remove the drinking vessel 5 from the device 10 again and, for example, place it under the outlet 3 for filling.

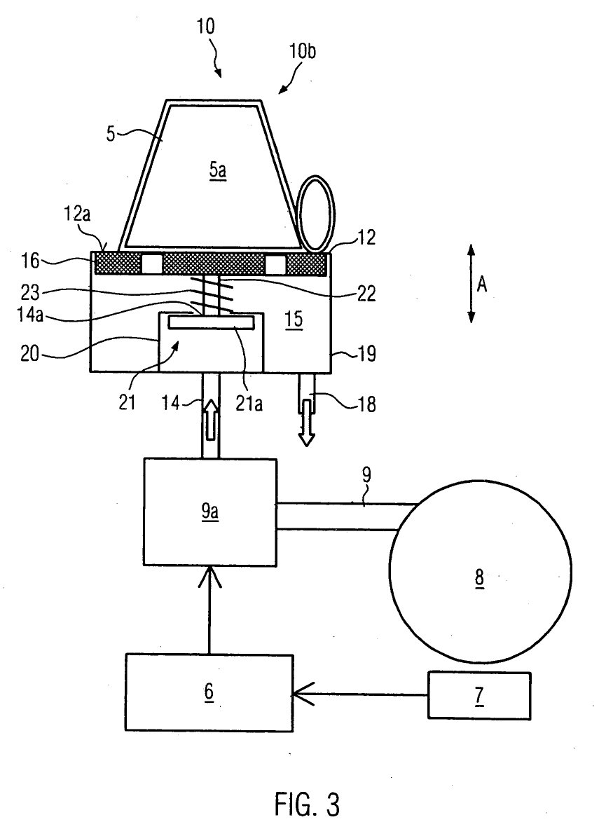

FIG. 3 shows a further embodiment 10b of the device 10 according to the disclosure, whereby components that are the same or comparable are identified with the same reference numbers and are not explained again. The embodiment 10b can also be integrated into the drink machine 1 or it can be formed as a separate device and provided, where appropriate, with its own steam generator.

The embodiment 10b depicted in FIG. 3 differs from embodiment 10a shown in FIG. 2 in that the embodiment 10b has a guiding housing 19, in which the cover 12 is supported in such a way that it can be moved up and down in the direction of the double-headed arrow A. The guiding housing 19 furthermore accommodates the steam distribution chamber 15 and a housing 20, not shown in more detail, for a valve 21, which is formed here as a mechanical valve, that opens and closes a steam intake opening 14a that is connected to the steam intake 14. The valve 21 contains a valve head 21a, which is connected to the cover 12, preferably with a plunger 22, in such a way that the valve head 21a follows the movements of the cover 12. Furthermore, a return mechanism 23 is provided that ensures that the cover 12 is always located in a first, outside-most (preferably top) position, in the direction of the arrow A, in the guiding housing 19 and remains in that position. Because the valve head 21a lies against the side of the inlet opening 14a that faces the steam inlet 14 in a way that forms a seal, this can also be supported by an applied steam pressure. The return mechanism 23, however, furthermore contains a spring that supports itself on the valve housing 20 and the underside of the cover 12.

The already described valve 9a is furthermore provided in the steam delivery 13. As a result of the arrangement of two valves, i.e., the first valve 9a and the second valve 21, even greater safety for the user is achieved.

The embodiment 10b of the device 10 is operated by the user placing his/her drinking vessel 5 inverted, as described using FIG. 2, on to the covering surface 12a, so that all openings 16 are covered. Then the valve 9a is opened via an operating element 7 in the manner described and the user presses the drinking vessel 5 in the direction onto the cover 12, whereby better sealing contact is created and the second valve 21a is opened, if this has not already happened due to the weight of the drinking vessel 5 itself. Steam then flows through the inlet opening 14a into the steam distribution chamber 15 and from there through the openings 16 into the interior 5a, and this steam preheats the drinking vessel 5.

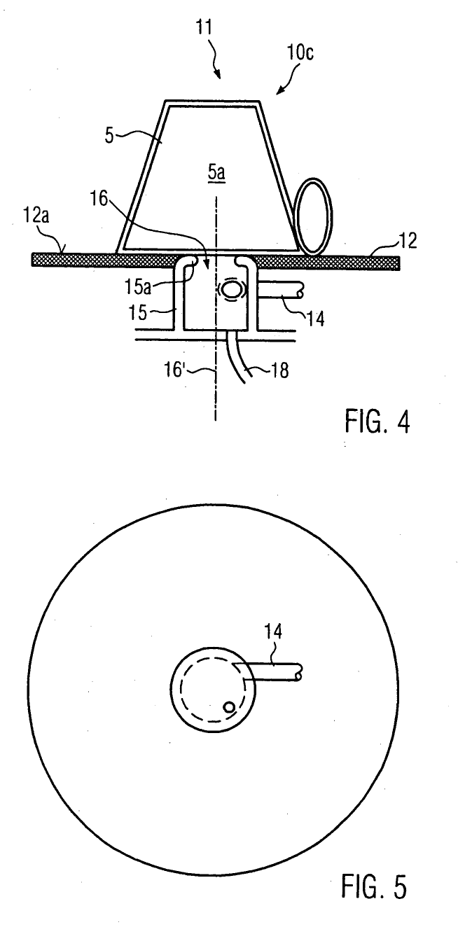

In FIG. 4 and FIG. 5, a third embodiment 10c of the device according to the disclosure is apparent. Components that are the same or comparable are identified with the same reference numbers used in the preceding embodiments, and only the differences are explained in the following. The embodiment 10c of the device 10 according to the invention also contains a receptacle mechanism 11 for the drinking vessel 5, which has a cover 12 with a covering surface 12a. The covering surface 12a is penetrated by a single opening 16, which connects a steam distribution chamber 15 to the interior of a drinking vessel 5 that is placed inverted on to the covering surface 12a. Furthermore, a steam intake 14 and a condensate outlet line 18 are provided.

In this embodiment, the steam intake 14 empties at a right angle into a vertical center line 16′ of the opening 16. In this way, the steam flow can first abate before it goes through the opening 16. Preferably, however, the steam intake 14 empties tangentially into a roughly circular-cylindrically shaped steam distribution chamber 15, so that a cyclonic-like flow results in the steam distribution chamber 15, leading to a strong abatement of the steam flow, so that users are not endangered. The abatement of the steam flow can be further increased by an upper edge 15a, which is bent inwards, i.e., into the steam distribution chamber 15, whereby this upper edge 15a extends around the opening 16 and particularly holds back the cyclonic-like flow in the steam distribution chamber 15, i.e., prevents it from escaping through the opening 16, until the speed of the steam has been sharply reduced.

As in the preceding embodiments, the condensate conduction 18 empties from the bottom of the steam distribution chamber 15 that lies opposite the opening 16, i.e., close to or at the lowest point, but preferably offset to the side of the centre line 16′.

In a modification of the described and drawn embodiments, the device according to the disclosure can be modified by means of having the drinking vessel come into contact with the covering surface with the opening pointing upwards, either by lowering the covering surface on to the drinking vessel or by pressing the drinking vessel from below against the covering surface. As a result, the steam delivery naturally comes from above. The steam delivery can furthermore be opened by means of only a single valve, for example, only by the mechanical valve. The valve or valves can also have other construction designs. Where appropriate, a curvature in the steam delivery is sufficient as a labyrinth section. The steam delivery can also be provided into the cover from the side and then, for example, reach the interior of the drinking vessel through openings arranged in the line at right angles to the flow direction of the steam.

We claim:

1. Device (10) for heating a drinking vessel (5) comprising a receptacle mechanism (11) for the drinking vessel (5), a cover (12) that contains a covering surface (12a) for the opening of the drinking vessel (5), a steam delivery (13) into the interior (5a) of the drinking vessel (5), the steam delivery (13) having a steam distribution chamber (15) arranged on a side of the cover (12) that lies opposite the covering surface (12a), the steam distribution chamber (15) being connected to a steam intake (14) and leading to at least one opening (16) in the covering surface (12a).

2. Device according to claim 1, wherein the steam distribution chamber (15) is formed as a condensate collection device (17).

3. Device according to claim 1, wherein the steam delivery (13) contains at least one valve (9a, 21) that can be operated by a user to open the steam delivery (13).

4. Device according to claim 3, and a first valve (21) that can be operated mechanically by a movement of the cover (12) and a second valve (9a) that can be operated by an operating element (7) are provided.

5. Device according to claim 1, wherein the at least one opening (16) is formed as a through-hole in the cover (12) and extends through the cover.

6. Device according to claim 1, wherein the covering surface (12a) has a steam-permeable area with a plurality of openings (16).

7. Device according to claim 1, wherein the steam supply (13) contains a steam labyrinth section.

8. Device according to claim 7, wherein the steam labyrinth section is formed by the steam intake (14) and the at least one opening (16), which are offset from each other and lead into the steam distribution chamber (15).

9. Device according to claim 1, wherein the steam intake (14) leads into the steam distribution chamber (15) to form a cyclonic section that is one of transverse or tangential to the at least one opening (16).

10. Device according to claim 1, wherein the covering surface (12a) is formed as a positioning base for the drinking vessel (5).

11. Device according to claim 1, wherein the covering surface (12a) has a sealing surface around the circumference for an edge of the drinking vessel (5).

12. Drink machine (1) with a steam preparer (9), comprising a device (10) according to claim 1, wherein the steam preparer (9) is connected to the steam delivery (13).

13. Drink machine according to claim 12, and a control means (6) for controlling drink preparation processes and drink dispensing processes and a steam delivery (13) provided with a valve (9a), wherein the valve (9a) is connected to the control means (6).

14. Device according to claim 3, wherein the steam delivery (13) contains two valves that can be operated by the user to open the steam delivery (13).
